(19) United States
(12) Patent Application Publication
(10) Pub. No.: US 2005/0131783 A1
(43) Pub. Date: Jun. 16, 2005

(54) System, method, and computer program product for network-based part management system

(76) Inventor: Myoung Jin, Scottsdale, AZ (US)

Correspondence Address: Peter B Goldman;Leonard Felker Altfeld Greenberg & Battaile, 250 North Meyer Avenue, Tucson, AZ, 85701, US

(21) Appl. No.: 10/506,795

(22) PCT Filed: Mar. 12, 2002
(86) PCT No.: PCT/US02/07514

(51) Int. Cl. G06F 17/60

(52) U.S. Cl. 705/34; 705/40

(57) ABSTRACT

The present invention provides a part management system that facilitates an automated process for the design or electronic components such as printed circuit boards. Manufacturing rules can be stored with part data to ensure that the manufacturing rules are considered throughout all aspects of the design process. A part research engine is provided that performs various functions to aid a designer in selecting parts to be included in the design of a component. The part research engine performs a global part number search. Entering a full or partial part number results in list of part numbers from which selections can be made. The part research engine also can perform a comparative part search. This function is used for finding an equivalent device within and across different manufacturers based on top-level parameters such as the density, package type, I/O requirements, and other factors. Users can select multiple components from the competitive part list for comparing them side-by-side using a direct compare feature of part research engine. A unified part file, part repository and database solve the problems of fragmented part libraries, use of generic part data, and lack of manufacturing rules. A unified part file is used to store part data required to support a suite of design and validation activities throughout the design cycle including the schematic (logical) design, PCB design and layout, thermal analysis, signal integrity and BMI analysis, and manufacturing analysis. The part data represent a manufacturer specific part identified by the manufacturer part number (MPN) instead of a generic part. Upon selection of a part for the schematic design, engineers of various disciplines can start investigating or preparing for the effect of the part selection on various aspects of the design while purchasing people can check pricing and availability of the part.

### FIELD

The present invention relates broadly to computer systems that facilitate the design of electronic equipment Specifically, the present invention provides a database management system for use with electronic design automation tools that are implemented in the form of application software packages.

### BACKGROUND

Electrical design engineers often spend up to 40% of their time on a project researching electronics parts and creating corresponding part data that can be used by electronic design automation (EDA) tools. Part selection is the single most important factor in determining the cost, performance, and reliability of electronic components.

The process of researching part data for exiting EDA tools is inefficient. Part vendors have compiled data books to serve as a part data source. With the proliferation of global computer networks such as the Internet, some vendors have made their part data available on websites. For part research and selection, engineers must visit numerous sites to access and compare part data. Because this is a time-consuming, largely manual process, network-based part research does not provide a significant improvement over researching part data in printed data books. The process of creating part data for existing EDA tools is also inefficient. To use parts in an electronic product design, the part data must be organized in a format that is compatible with EDA tools. Part data in printed data books or PDF files at a vendor website cannot be easily translated into the EDA tool compatible format. Thus, design development is performed through error-prone, time-consuming manual processes with the use of editors included in the EDA tool.

Existing part libraries are fragmented. EDA tools enable the construction of part libraries to reuse part data in multiple designs. However, EDA design and validation tools are fragmented, targeting specific engineerng disciplines, and are designed to support a serial design process of schematic (logical) design, physical design, and design validations. Existing EDA tools utilize part libraries that contain only the data used by only one tool. The user needs to build multiple part libraries such as local symbol library, package and footprint library, thermal component library, and device model library for the same parts. Part libraries are specific to EDA tool vendors. Each EDA tool has its own proprietary part data format. A part library constructed for a tool from one EDA tool vendor cannot be used for a tool of the same functionalities from another EDA tool vendor. Using tools from multiple EDA vendors requires a user to build multiple, vendor specific part libraries for the EDA tools.

Maintaining a corporate part library is difficult using existing systems. Companies using EDA tools find it advantageous to build and main a corporate part library to eliminate the duplicated efforts of multiple design groups within the company and control the quality and usage of parts. The library can be accessed through a computer network within the company. Fragmented EDA tool specific libraries and the need to maintain the library in multiple EDA tool vendor specific formats make the construction and maintenance of a corporate part library very expensive. While current electronics product designs frequently require collaboration among people from multiple companies and remote locations, access to the LAN-based corporate library is quite limited.

Data stored in part libraries are often insufficient and outdated. Existing part libraries do not follow the part life cycle automatically, which results in a library containing many obsolete parts. A part library user has little knowledge on the availability of the parts. The part library contain only the data used by EDA tools. The user may require additional information the part such as full datasheet and application notes before selecting a part from the library to use for a product design.

The EDA tool provided and the corresponding user-built part libraries usually contain generic part data such as generic logic symbols and generic package data. The generic part data are used in logical and physical designs. Although pat selection greatly affects product cost, performance, and reliability, selection of manufacturer specific parts is performed at a later stage of the design or frequently after completion of the design. Manufacturer specific part selection based primarily on price and availability can create problems related to product performance, reliability, and manufacturing. Also, purchasers and contract manufacturers may require part selection information as early as possible for part procurement.

Current EDA tools lack manufacturing rule consideration. Part package and footprint data used by EDA tools includes pad-stack data for individual pins of a part Pad-stack data is unique to the specific process or rules of manufacturing the printed circuit board (PCB) on which the part is mounted With increased density of package pins, pad-stack data supporting specific manufacturing rules becomes more important. Current EDA tools support a single set of the pad-stack data, which doesn't address unique manufacturing rules. Current EDA tools also lack quality control, approval, and usage control processes. Manual entry of the part data is prone to errors and frequently done by non-experts. Automated part creation tools and automated procedures for part request, creation, and approval are needed. There is also a need to control the selection and usage of individual parts based on constantly updated approved vendor lists (AVL) and manufacturing rules and processes.

There is a heartfelt need for a part management system that can significantly reduce the time required for part research and data creation and improve the part selection process.

### BRIEF DESCRIPTION OF THE INVENTION

The present invention provides a part management system that facilitates an automated process for the design or electronic components such as printed circuit boards. A part research engine is provided that performs various functions to aid a designer in selecting parts to be included in the design of a component. The part research engine performs a global part number search. Entering a full or partial part number results in list of part numbers from which selections can be made. The part research engine also can perform a comparative part search. This function is used for finding an equivalent device within and across different manufacturers based on top-level parameters such as the density, package type, I/O requirements, and other factors Users can select multiple components from the competitive part list for comparing them side-by-side using a direct compare feature of part research engine.

A unified part file, part repository and database, solve the problems of fragmented part libraries, use of generic part data, and lack of manufacturing roles. A unified part file is used to store part data required to support a suite of design and validation activities throughout the design cycle including the schematic logical) design, PCB design and layout, thermal analysis, signal integrity and EMI analysis, and manufacturing analysis. The part data represent a manufacturer specific part identified by the manufacturer part number (MPN) instead of a generic part. Upon selection of a part for the schematic design, engineers of various disciplines can start investigating or preparing for the effect of the part selection on various aspects of the design while purchasing people can check pricing and availability of the part.

The usage of individual parts in compliance with specific manufacturing rules or precesses or for specific customer companies can be controlled by the parts management system. Multiple pin pad-stacks representing different PCB manufacturing roles can be associated with a part. Users can select a pad-stack representing the actual manufacturing rules to be followed when the part is incorporated into a specific PCB design. Users can also use the parts management system of the present invention to build and maintain a usage key list. The part management system allows users to maintain the approved vendor list (AVL) or preferred manufacturer list. Upon selection of a part in the part repository, the manufacturer of the part is checked against AVL. The user is then informed of whether or not the manufacturer of the part is approved.

When a PCB designer wants to use part information that isn't stored in the part repository, a part creation request and tracking system allows the designer to fill out a part creation request form and submit it for review by management. Requests are logged and available for viewing by all project members. During the part creation process, the progress of parts specialists can be posted to users. The parts management system divides the part data creation process into four stages: logical symbol creation, package and footprint data creation, thermal data creation, and electrical data creation. Each data creation step may require different specialist. Pending or Completed for each data creation step is used for posting the part creation status. Upon completion of the part creation step, the part information is sent to a surest for an approval. The approved part information is put in the part repository and the part creation request record is either archived or deleted.

May other features and advantages of the present invention will be realized by those skilled in the art while reading the following detailed description in conjunction with the drawings, in which:

### BRIEF DESCRIPTION OF THE DRAWINGS

FIG. 1 illustrates in block diagram form the major components of the network-based parts management system of the present invention;

FIG. 2 illustrates the contents and organization of a typical file stoned in the unified part database;

FIG. 3 illustrates in block diagram form the major components of the part editor;

FIG. 4 illustrates a part import and export module that includes translators for vendor specific formats;

FIG. 5 is an illustration of a client sad computer architecture communicating over a computer network according to the present invention; and

FIG. 6 is a schematic in block diagram form illustrating the major components of a computer that may be used for the server computer or client computers of FIG. 5.

### DETAILED DESCRIPTION OF THE INVENTION

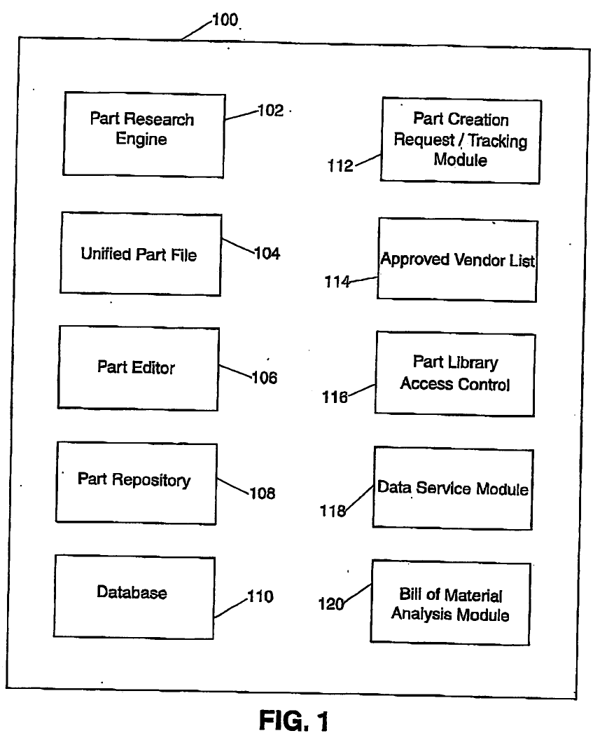

FIG. 1 illustrates in block diagram form the major components of the pats management system of the present invention. Parts management system 100 includes parts research engine 102, unified parts file 104, part editor 106, part repository 108, database 110, part creation request and tracking module 112, approved vendor list 114, part library access control module 116, data service module 118, and bill of material analysis module 120.

The part research engine 102 performs various functions to aid a designer in selecting parts to be included in We design of a component such as hose used in printed circuit board. The part research engine 102 performs a global part number search. Entering a full or partial part number results in list of part numbers from which selections can be made. Users can retrieve the detailed feature attributes of each part and access corresponding data and application notes. The part research engine 102 also can perform a comparative part search. This function is used for finding an equivalent device within and across different manufacturers based on top-level parameters such as the density, package type, I/O requirements, and other factors. Users can select multiple components from the competitive part list for comparing them side-by-side using a direct compare feature of part research engine 102.

The part research engine 102 also includes a migration tool that includes a dynamic selector guide to provide a top-level table view of the entire product family from the selected component. For a selected component, the dynamic selector guide finds all components belong to the same product family and lists them in tabular form showing key features such as density, type, vendor, screening level, package type, peak bandwidth range, and operating supply voltage of each component to allow for user comparison.

The part engine 102 allows users to request part searches based on the selection of key parameters such as product family, manufacturer, density, performance, package, and I/O. The search result cam be further used for attributes of the part, according to the datasheet and application notes, and comparing parts side-by-side.

Users can direct the part research engine 102 to download the key attributes of the part into the unified part file 104. Typical key attributes include part name, manufacturer, description, function type, technology, package type, package name, pin count, power dissipation, operating temperature range, and datsheet link URL. While the part data is downloaded, a logic symbol creation wizard is utilized to allow the user to create a logic symbol that represents the downloaded part. The logic symbol is then stored with the downloaded part data in a part data file. The part data file am be directly used for a schematic design or can be edited using the part editor 106 to add other attributes of the part required to support physical design and validation functions.

The unified put file 104 solves the problems of fragmented part libraries, use of generic part data, and lack of manufacturing rules. In the preferred embodiment a Java binary jar file is used to store part data required to support a suite of design and validation activities throughout the design cycle including the schematic (logical) design, PCB design and layout, thermal analysis, signal integrity and EMI analysis, and manufacturing analysis. The part data represent a manufacturer specific part identified by the manufacturer part number (MPN) instead of a generic part Upon selection of a part for the schematic design, engines of various disciplines can start investigating or preparing for the effect of the part selection on various aspects of the design while purchasing people can check pricing and availability of the part. Multiple pin pad-stacks representing different PCB manufacturing rules can be associated with a part. Users can select a pad-stack representing the actual manufacturing rules to be followed when the part is incorporated into a specific PCB design.

Part repository 108 allows users to build part libraries. Multiple part repositories can be implemented. In an embodiment, each project group of engineers has a separate part repository and uses it to build a project-level part library. Users also can create a shared repository to build a corporate library supporting multiple design project groups. Part information placed in the part repository 108 a undergoing a quality control and approval process can be downloaded to a user's computer for use in electronic designs and validations.

When a part file is uploaded to the part repository 108, a subset of the key information of the part is stored in database 110 instead of storing entire part data in the database 110. In the preferred embodiment, database 110 can be a database application software system such as available from Oracle Corp. of Redwood City, Calif. Key information stored in database 110 can include manufacturer part number, functional part number, description, manufacturer, functional type, technology, package type, package name, and datasheet link URL. The original part file is then stored in its entirety in the repository 108. The division of information conserves resources in the database 110, provides quicker access to the data, and reserves expansion of the unified part database. The key information stored in database 110 can be viewed to aid the user to select the part data for downloading. When the part repository 108 bas a large number of parts, a browser or search engine can be used to quickly find palls. A parametric search engine (not shown) is provided within the parts management system 100. Any combination of parameters included in the key information can be used by the search engine to perform a search.

The usage of individual parts in compliance with specific manufacturing rules or processes or for specific customer companies can be controlled by the parts management system 100. Users build and maintain a usage key list In an embodiment, the usage key includes up to 6 alphanumeric characters. A usage description can be attached to each usage key. When a part is uploaded to the repository, the user can select one or more usage keys for the part. The usage keys assigned to the part we stored in database 110 and shown when the key information of the past is displayed.

In a preferred embodiment, the part management system 100 is used by an electronics design company. Bach company has a list of component manufacturers from which the company frequency buys or prefers to buy components. The part management system 100 allows users to maintain the approved vendor list (AVL) 114 or preferred manufacturer list. Users can maintain multiple instances of AVL 114 for different product families. AVL 114 contains one or more applicable product family names as well as the names of manufacturers approved for the products. Project group members can view AVL 114 at any time, and parts in the pan repository 108 and parts in a bill of materials (BOM) can be checked against AVL 114 automatically. For an effective cross checking of the manufacturer names, the same manufacturer naming conventions are used for the part editor 106 and AVL 114. Upon selection of a part in the part repository 108, the manufacturer of the part is checked against AVL 114. The user is then informed of whether or not the manufacturer of the part is approved.

When users select parts to download from the repository, a list of EDA tool vendor specific part data formats is offered for the user selection. The part data is then translated to the selected EDA tool specific format, such as Cadence logical part and Mentor physical pare and downloaded to the user's computer. To maintain part histories, uploading and downloading information for part information in full part repository 108 is maintained and can be displayed. The uploading and downloading information includes the date and user name for each activity.

To insure quality of the part data and control the approval process, users can use the parts management system 100 to restrict the part creation work to part specialists. One or more specialist can be involved in creating a complete part. When a PCB designer wants to use part information that isn't stored in the part repository 108, the part creation request and tracking system 112 allows the designer to fill out a part creation request form and submit it. Requests are logged and available for viewing by all project members.

During the part creation process, the progress of parts specialists can be posted to users. The parts management system 100 divides the part data creation process into four stages: logical symbol creation, package and footprint data creation, thermal data creation, and electrical data creation. Each data creation step may require different specialist. Pending or Completed for each data creation step is used for posting the part creation status. Upon completion of the part creation step, the part information is sent to a superior for an approval. The approved part information is put in the part repository 108 and the part creation request record is either archived or deleted.

A project group part library can be defined in terms of the part repository 108, part con request and tracking system 112, and AVL 114. While the part library is useful for sharing the data with many designers and supporting many design projects, there is also a need to control access to die part library because of security reasons. The following features are provided in the parts management system 100 to control the part library access.

An administrator of a project group can allow other project group members to access the project group's part library by entering the names of allowed project groups into part library access control module 116. This feature is especially useful for a project group devoted to maintain a corporate part library. The part library access control module 116 can also be used to control access of individual members of the project group to the part libraries. This feature is useful for controlling library access by people who are not employees of the company or whose work as is irrelevant to the part selection for a design. When a user is allowed to access part libraries and the project group is granted to access other project group libraries, the part library access control module 116 displays the available part libraries and allows the user to select one. The user can change the selection as desired.

While accurate package and footprint data for a part is very important for the physical layout of PCB design and eliminating potential costly manufacturing problems, creating the part data can be time-consuming. There are significant cost and time advantages of using a subscription-based part data service rather than creating the part data inhouse. Parts management system 100 includes a part data service nodule 118 that links uses with a part data service that creates part data on demand. By utilizing part data service module 118, users minimize internal costs and raise quality levels while maintaining consistency of engineering data across distributed design processes and manufacturing supply chains.

The data service module 118 receives a user's order and delivers package and footprint data of manufactures parts. Data service module 118 utilizes Valor Part Library (VPL) containing accurate and comprehensive models of over 20 million commercially available components. If the requested part is not available in VPL, part data is assembled by a specialist and delivered to the user via the data service module 118. A flat, per part service charge is applied and automatically added o the customers account balance upon delivery of the part data.

Knowing the price and availability of parts selected for the design as early as possible in the design stage is an advantage to electronics developers. When the part is not available or the cost is too high, the alternative part must be found. The early selection of manufacturer specific parts gives the purchasing people or contract manufacturers sufficient lead time for ordering the parts and allows multiple engineering disciplines to investigate and resolve the related design and manufacturing issues early in the design cycle.

The parts management system 100 includes a bill of material analysis service module 120. A bill of material (BOM) or part list can be get out of a schematic design or PCB design. The bill of material analysis service module 120 communicates with one or more electronic component distributor to analyze the customer's BOM and return with prices and availability of the individual parts in the BOM. Information on the available alternative manufacturer parts and their prices are also provided to the customer.

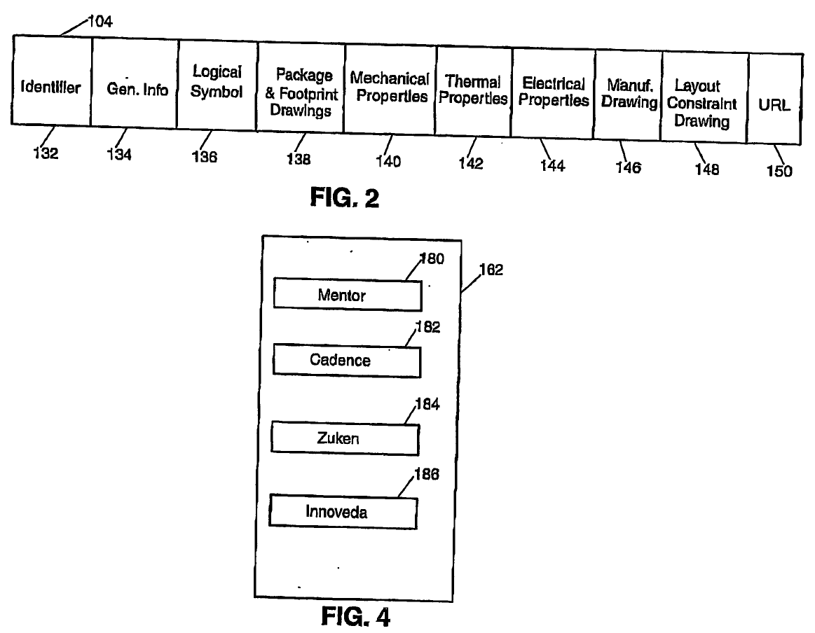

FIG. 2 illustrates the contents and organization of a typical unified part file 104. Identifier 132 includes identifiers and/or key attributes that can be used to locate or indicate a specific part Examples of identifier 132 include manufacturer part number, functional (generic or internal) part number, etc. General information 134 may include manufacturer name, functional type, technology, passive component value, etc. Logical symbol 136 is also stored in the unified part database. Logical symbol 136 is graphical drawing in electronic form that is used for a schematic design. Logical symbol 136 can be either a gate level logical symbol or a package-level logical symbol. Package and footprint drawing 138 is a graphical drawing, stored in electronic form, that shows the package outline, pin locations and the pin pad-stacks used for PCB layout. Multiple instances of package and footprint drawing 138 can be included in the unified part file 104, for instance in cases where multiple padstacks are associated with a part. Mechanical properties 140 includes information such as package type, package name, body height, mounting typo, and minimum placement clearance in X, Y, and Z dimensions are stored.

The information stored in mechanical properties 140 is used as parameters for placing components on PCBs and thermal modeling. Thermal properties 142 includes part information used for thermal validation such as power dissipation, junction-to-case and junction-to-board thermal resistances, surface radiation emissivity, and operating temperature range. Electrical properties 144 includes part information such as functional type, device model and signal pull-up reference signal, and pull-down reference signal names of each pin as well as the, package resistance, capacitance, and inductance values of each pin. The information stored in electrical properties 144 is used to support signal integrity and EMI validations. Manufacturing drawings 146 are drawings stored in electronic that are used for manufacturing of PCBs. Manufacturing drawings 146 typically include silkscreen top and bottom drawings and assembly top and bottom drawings. Layout constraint drawings 148 are electronic representations of drawings such as placement boundary, via keepout area, and trace keep-out area that are stored to use for placing components, placing vias, and routing traces. URL link 150 contains a universal resource locator that is associated with the part data stored in the unified part file 104. The URL link 150 may be a datasheet link that allows users to access more detailed and most recently updated part information such as datasheet and application notes. URL link 150 thus provides detailed information to a user without occupying storage space in the information in the unified part file 104.

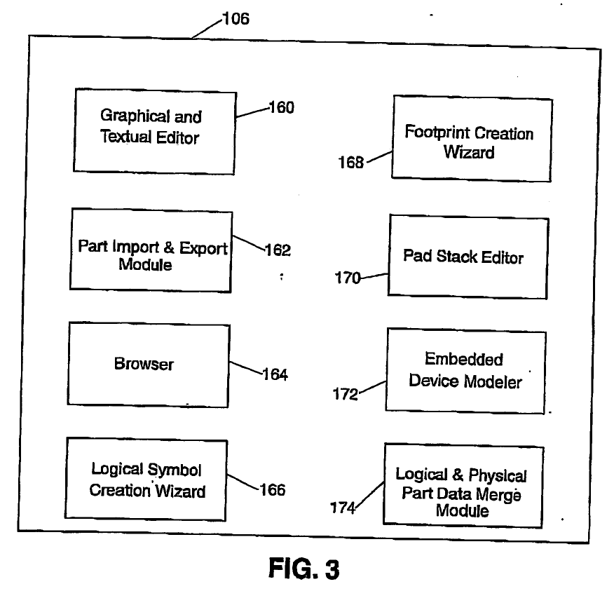

FIG. 3 illustrates in block diagram form the major components of the part editor 106. The part editor 106 includes comprehensive graphical and textual editors 160, part import and export module 162, datasheet URL link module 164, logical symbol creation wizard 166, footprint creation wizard 168, pad stack editor 170, embedded device modeler 172, and logical and physical part data merge module 174.

In the part management system 100, part data are created when users download components from outside part research sites, order part data service, or read in existing parts in third party EDA tool format through a part data translator. Graphical and textual editors 160 can also be used to create a new part or view and edit the drawings or properties of existing parts. The data contained in the unified part file 104 can be created or edited with the use of the graphical and textual editors 160. In the case where part data are downloaded from an outside site or read in using a part translator, the graphical and textual editors 160 can be employed to enter missing data for the created parts before sending them to a corporate or project-level part library. Part import and export module 162 allows the part management system 100 to interface with EDA tool-specific part data files that cannot be used by EDA tools from different vendors. Part import module eliminate the duplicated effort in prior systems for creating EDA tool specific parts and maintaining the multiple part libraries for identical parts. Users greatly benefit from maintaining single part library that can support all EDA tools used in the design process.

Providing bi-directional translators between the unified part database and various EDA tool format part data files allows users to maintain a single part library. Existing EDA tool specific parts can be converted between different formats, thus allowing part repository 108 to be used by third party EDA tools. As shown in FIG. 4, the part import and export module 162 includes translators for vendor specific formats such as the mentor translation submodule 180, the Cadence translation submodule 182 the Zuken translation submodule 184, and the Innoveda translation submodule 186. While part import and export module 162 is explained and illustrated to have four submodules, it is to be understood by those skilled in the art that any desired vendor format and emerging part data standard format can be added to the part import and export module 162 in the form of a Elation submodule.

When part information stored in the part repository 108 is described in more detail at a manufacturer website, a link stored with the part information can be displayed to the user, and, using an Internet browser 164, the user can access the website to obtain additional part information.

Part editor 106 also includes logical symbol creation wizard for creating logical symbols and footprint creation wizard 168 for creating package footprints in a quick and automated way. The wizards 166, 168 can handle different package types and pin arrangements with minimal user input.

The pad-stack editor 170 is included in the part editor 106. Pad-stark editor 170 allows uses to create pin padstacks of various shapes and sizes that accommodate PCB manufacturing rules. The pad-stacks created for one part can be output in a file stored in a pad-stack library similar to part repository 108. The pad-stacks in the library cam be used for many other parts. Bach part can keep multiple different pad-stacks. Among the multiple pad stacks users can select one when the part is selected for specific PCB design requiring unique manufacturing rules.

Once device models such as drivers, receivers, and terminators are assigned to individual pins of the par & device models become property of the part The embedded device modeler 172 allows users to view the device models and edit them. The device models are used for signal integrity and EMI analyses. Linear, IBIS behavioral, and transistor-level Spice models are supported.

In the device modeler 172, the user can create a models for devices such as a linear driver, receiver, or terminator model by em the electrical characteristics of the device. Upon loading an IBIS file, the device modeler 172 creates SPICE circuit simulator compatible models automatically for all models described in an IBIS format. Upon loading a transistor-level SPICE model, the device modeler 172 transforms the original file into a file formatted to have I/O terminals and model specifications consistent with the linear and IBIS behavioral device model files.

Many parts have identical logical symbols or package footprint data. Also existing third party EDA tool format part data file containing the logical symbol is separated from the part data file containing the physical part data. The merge module 174 allows users to get the logical part data by copying it from another part or reading in a third party EDA tool format logical part and the physical part data by copying it from another part or reading in a third party EDA tool format physical part and then merges the logical and physical parts together to create a new part.

Directing attention to FIG. 5, a client server computer architecture communicating over a computer network is illustrated. Server 210 is a computer that administers resources that are delivered over computer network 212 to client computers 214-1, 2142, . . . , 214n, where n is the number of client computers serving users with access to the server 10. In the preferred embodiment, computer network 212 is a public computer network such as the Internet, but smaller, ovate computer networks, such as local or wide area networks, can also be used. Those skilled in the art will understand that server 210 may be a plurality of computers and application software arranged in a network to provide a large amount of computing resources to serve a large number of clients, or a single computer system to serve a smaller number of clients, as in the case of a local or wide area network.

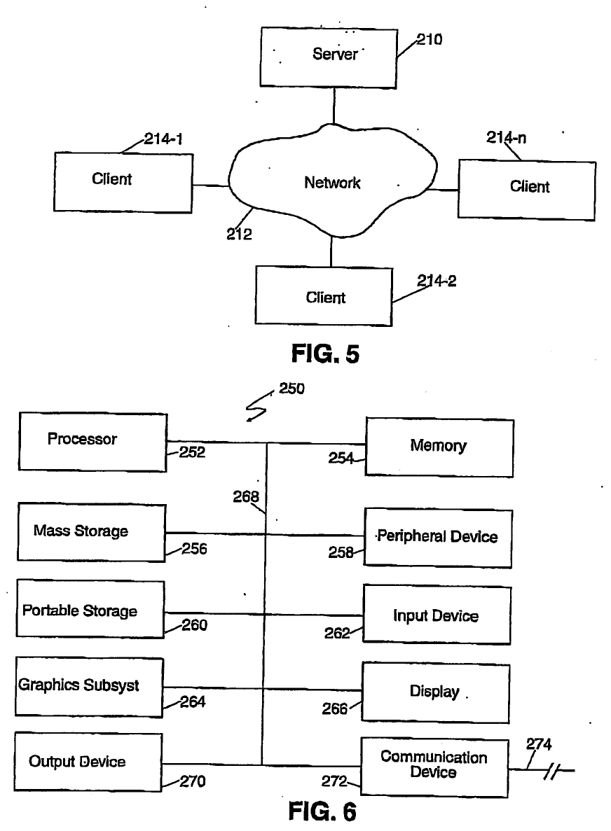

FIG. 6 is high-level block diagram view of an embodiment of a computer system suitable for administering the pare management system of the present invention Server 210 and the clients 214 may be implemented on computer systems such as the one shown in FIG. 5. The computer system 250 includes a processor 252 and memory 254. Processor 252 may contain a single microprocessor, or may contain a plurality of microprocessors for configuring the computer system as a multi-processor system. Memory 254, stores, in part, instructions and data for execution by processor 252. For example, the server 210 includes in memory 254 the application software for administering the network-based parts management system. The clients 214 also may include browser software in memory 254 for accessing a website maintained by the server 210 and using the network-based parts management system. If the system of the present invention is wholly or partially implemented in software, including a computer program memory 254 stores the executable code when in operation. Memory 54 may include banks of dynamic random access memory (DRAM) as well as high speed cache memory. The system 50 further includes a mass storage device 256, peripheral device(s) 258, portable storage medium drive(s) 260, input device(s) 262, a graphics subsystem 264 and a display 266. For simplicity, the components are depicted as being connected via a single bus 268. However, the components may be connected through one or more data transport means. For example, processor 252 and memory 254 may be connected via a local microprocessor bus, and the mass storage device 256, peripheral device(s) 258, portable storage medium drive(s) 260, and graphics subsystem 264 may be connected via one or more input/output (I/O) buses. Mass storage device 256, which is typically implemented with a magnetic disk drive or an optical disk drive, is a non-volatile storage device for staring data and instructions for use by processor 252. In another embodiment, mass storage device 256 stars the computer program implementing the method of automating a microelectronic manufacturing process for purposes of loading such computer program to memory 254. The method of the present invention also may be stored in processor 252. Portable storage medium drive 260 operates in conjunction with a portable non-volatile storage medium, such as a floppy disk or other computer readable medium, to input and output data and code to and from the computer system 250. In one embodiment, the method of the present invention for facilitating a electronic component design process is stored on such a portable medium, and is input to the computer system 250 via the portable storage medium drive 260. Peripheral device(s) 258 may include any type of computer support device, such as an input/output (I/O) interface, to add additional functionality to me computer system 250. For example peripheral device(s) 258 may include a network interface card for interfacing computer system 250 to a network, a modem, and the like. Input device(s) 262 provide a portion of a user interface. Input device(s) 262 may include an alphanumeric keypad for inputting alphanumeric and other key information, or a pointing device, such as a mouse, a track ball, stylus or cursor direction keys. In order to display textual and graphical information, the computer system 250 includes graphics subsystem 264 and display 266. Display 266 may include a cathode ray tube (CRT) display, liquid crystal display (LCD), other suitable display devices, or means for displaying, a enables a user to interact with the computer program to configure the application objects and implement the workflows. Graphics subsystem 264 receives textual and graphical information and processes the information for output to display 266. Display 266 can be used to display an interface to interact with die computer program to configure the application objects and implement the workflows and/or display other inflation that is part of a user interface. The display 266 provides a practical application of the method of automating a microelectronic manufacturing process since the method of the present invention may be directly and practically implemented through the use of the display 266. Additionally, the computer system 250 includes output devices 270. Examples of suitable output devices include speakers, printers, and the like. To connect the computer system 250 to network 212, communications device 272 controls the flow of data between the computer system 250 and computer network 212 via communication line 274. The components illustrated in the computer system 250 are those typically found in general purpose computer systems, and are intended to represent a broad category of such computer components that are well known in the art. The computer system 250 illustrates one platform that may be used for practically implementing embodiments of the present invention. Numerous other platforms can also suffice, such as Macintosh-based platforms available or Apple Computer, Inc., platforms with different bus configurations, networked platforms, multiprocessor platforms, other personal computers, workstations, main, navigation systems, and the like. Alternative embodiments of the use of the method of the present invention in conjunction with the computer system 250 further include using other display means for the monitor, such as CRT display, LCD display, projection displays, or the like. Likewise, any similar type of memory, other than memory 254, may be used. Other interface apparatus, in addition to the component interfaces, may also be used including alphanumeric keypads, other key information or any pointing devices such as a mouse, trackball stylus, cursor or direction key.

While the preferred embodiment of the present invention has been illustrated and described in detail, it is to be understood that the figures and detailed description are mercly illustrative and many modifications can be made without departing from the spirit of the invention.

1. A part management system for managing information for electronic parts used by electronics design automation tools, the system comprising:
a part research engine;
a part editor;
a creation request tracking module; and
a part repository.
